(19) United States
(12) Patent Application Publication
(10) Pub. No.: US 2014/0245998 A1
(43) Pub. Date: Sep. 4, 2014

(54) MODULE FOR SUPPLYING GAS TO A MOTOR VEHICLE ENGINE

(71) Applicant: Valeo Systemes de Controle Moteur, Cergy Saint Christophe (FR)

(72) Inventor: Samuel Leroux, Poissy (FR)

(21) Appl. No.: 14/351,289

(22) PCT Filed: Oct. 10, 2012
(86) PCT No.: PCT/FR2012/052299

§ 371 Date: Apr. 11, 2014

(30) Foreign Application Priority Data
Oct. 12, 2011 (FR) 1159234

(51) Int. Cl. F02M 25/07

(52) U.S. Cl. CPC F02M 25/0726
USPC 123/540

(57) ABSTRACT

The invention relates to a module (100) for supplying gas to an engine (6) of a motor vehicle, comprising a single dispenser (108), a gas cooler (107) provided with means (120, 146) for fixing to the cylinder head of said engine (6), and an intake box (109) connecting said single dispenser (108) to said cooler (107).

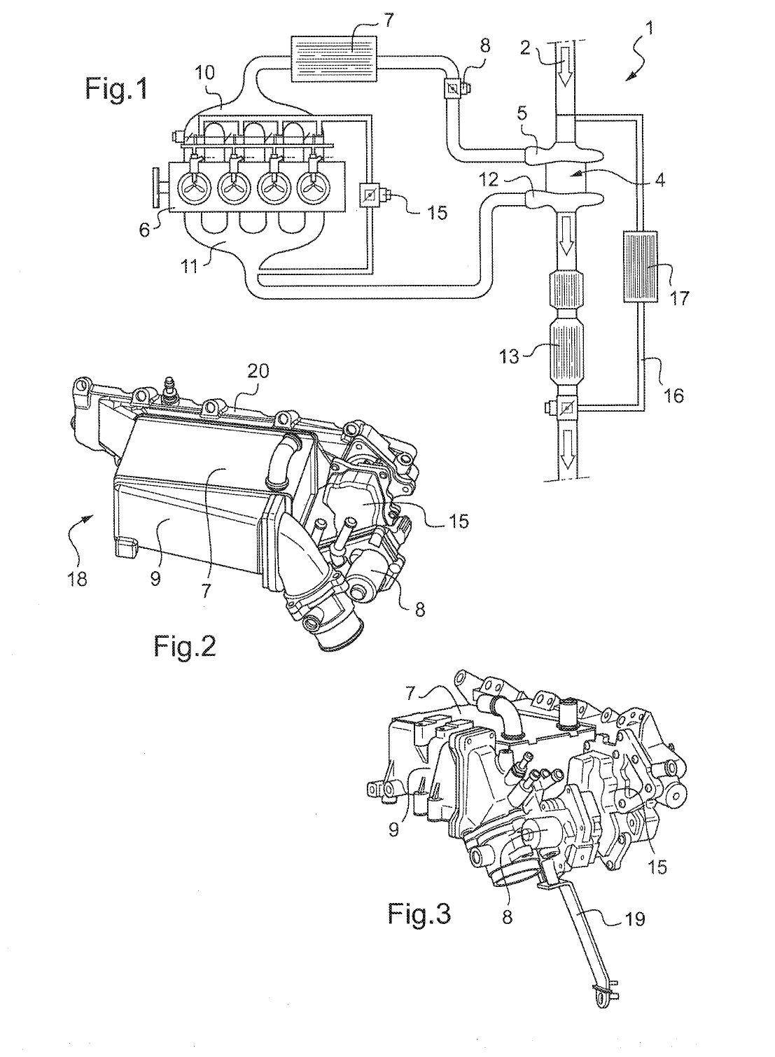

The invention relates to a module for supplying gas to a motor vehicle engine. Although the engine is generally supplied with air, the term “gas” is more appropriate, since it may in particular include a mixture of air and exhaust gases output by a parallel EGR (Exhaust Gas Recirculation) circuit. Typically, a circuit for supplying gas to a motor vehicle engine is shown schematically in FIG. 1. Such a circuit 1 comprises a gas inlet 2, the incident gas being intended, in a first step, to supply a turbocharger 4. The supercharger 5 sends pressurized gas toward the engine 6, this air being cooled beforehand by means of a gas cooler 7 positioned upstream of said engine 6. This supply of gas to the engine 6 can be interrupted by means of a single dispenser 8 positioned upstream of the cooler 7. The gas arrives, in a second step, in an intake manifold 10 positioned upstream of said engine 6. At the outlet of the engine 6, the gas escapes by means of an exhaust manifold 11 positioned downstream of said engine 6. The gas is then conveyed toward the turbine 12 of the turbocharger 4, which sends it toward a particle filter 13 before being expelled to the outside of the vehicle. A high-pressure EGR circuit 14 having a shut-off valve 15 connects the intake manifold 10 to the exhaust manifold 11. A low-pressure EGR circuit 16 provided with a low-pressure valve and a cooler 17 connects that part of the gas circuit 1 that is located upstream of the supercharger 5 to that part of said circuit 1 that is located between the filter 13 and the gas outlet.

For the rest of the description, it is implicitly assumed that the engine is provided with a cylinder head.

With reference to FIG. 2, it is known to collect, within one and the same module 18 for supplying gas, the gas single dispenser 8, the cooler 7 of the main gas circuit, an intake box 19 connecting these two elements 7, 8, a valve 15 which may for example be the valve 15 of the high-pressure EGR circuit, and an interface flange 20 for fixing said cooler 7 and said valve 15 to the cylinder head of the engine 6.

The gas single dispenser 8 is a heavy component which is fixed rigidly and laterally to the intake box 9. It is thus, in part, suspended in the air, creating a significant cantilever effect, which can cause significant forces at the connection between said single dispenser 8 and said intake box 9. The consequences of such a mounting configuration can lead to breakage of this connection, under the effect of wobbling of the module 18 brought about by the engine 6 in operation.

With reference to FIG. 3, a means for remedying this detrimental cantilever effect consists in installing a strut 19 that connects the single dispenser 8 to a fixed part of the vehicle, so as to provide support for said single dispenser 8 and thus to minimize the forces produced at the connection between said single dispenser 8 and said intake box 9. Such a fixing device has the drawback of displacing the forces from said connection to the support strut 19, which will react most often by bending or twisting, rapidly becoming non-operational, resulting again in this cantilever effect.

Application FR 2 953 255 relates to a double dispenser.

The module for supplying gas to a vehicle engine according to the invention is provided with a single dispenser which is connected to the intake box and has fixing means intended to anchor said dispenser to a fixed component of the vehicle so as to eliminate the cantilever effect encountered in already existing modules. In this way, once the module has been fitted in the vehicle, all the components of which it consists will be connected together and to surrounding components, in a secure and homogeneous manner, with no risk of deterioration of the various connections involved over time.

The invention relates to a module for supplying gas to a motor vehicle engine, comprising a single dispenser, a gas cooler provided with means for fixing to the cylinder head of said engine, and an intake box connecting said single dispenser to said cooler. The single dispenser comprises means for fixing to the cylinder head of said engine. In addition to being connected to the intake box of the cooler, the single dispenser will benefit from a second anchoring point on the cylinder head of the engine, once the module has been fitted on the engine, at the same time eliminating the cantilever effect observed in already existing modules for supplying gas.

Advantageously, the means for fixing the single dispenser and the means for fixing the cooler are positioned on the same side of said module. In this way, the means for fixing these two elements will add together to ensure solid and homogeneous fixing of the module to the cylinder head of the engine.

Preferably, the means for fixing the cooler and the means for fixing the single dispenser are arranged on said module so as to ensure a connection of said dispenser and of said cooler with the cylinder head of the engine in the same plane. With such a configuration, fixing of said module to the cylinder head of the engine is simplified, avoiding the need to precisely position different offset interface planes. Moreover, this configuration favors a reduced size of said module, without the latter allowing projecting elements to arise.

Preferably, the means for fixing the single dispenser is a flat fixing tab. This is a simple, low cost and secure fixing means which does not require any specific tools to anchor said dispenser on the cylinder head of the engine. It is assumed that this tab is connected rigidly to the single dispenser.

Advantageously, the means for fixing the cooler to the cylinder head comprise an interface flange, the fixing tab of the single dispenser being flush with said interface flange. In other words, the module according to the invention comprises a single face for attaching to the cylinder head of the engine.

Advantageously, the interface flange and the fixing tab are positioned side by side. In this way, the fixing of the single dispenser to the cylinder head does not interfere with the fixing of the cooler to said cylinder head.

Preferably, the fixing tab has at least one through-hole provided for a screw. Specifically, the connection of the single dispenser to the cylinder head of the engine consists in bringing a surface plane of the tab into contact with a surface plane of the cylinder head and then in fixing the final position of these two elements with respect to one another by means of at least one screw.

It is possible for the fixing tab to have no orifice designed to receive an outlet of the dispenser. The only through-orifices in the fixing tab may be those provided for the passage of the screws.

Preferably, the single dispenser is connected to the intake box by means of a duct, at least one of the two connections implemented to ensure this connection being produced by interlocking. Such an interlocking connection may provide the module according to the invention with a certain fitting flexibility, since it does not require the single dispenser to be positioned very precisely with respect to the intake box, and this type of connection enables relative movement of said single dispenser with respect to said intake box in the event of stresses generated in the module. According to a preferred embodiment of a module for supplying gas according to the invention, the two connections implemented by the duct between the intake box and the single dispenser are produced by interlocking.

The modules for supplying gas to a vehicle engine according to the invention have the advantage of having a robust structure that is resistant to stresses such as repeated vibrations brought about by the engine in operation, while having a compact geometry. They also have the advantage of implementing simple connecting means between the various components of which they consist and also with surrounding components, said means being inexpensive.

A detailed description of a preferred embodiment of a module for supplying gas to an engine according to the invention is given below with reference to FIGS. 1 to 6.

FIG. 1 is a schematic view of a circuit for supplying gas to a motor vehicle engine,

FIG. 2 is a perspective view of a module for supplying gas to a vehicle engine, according to the prior art,

FIG. 3 is a perspective view of another embodiment of a module for supplying gas to a vehicle engine, according to the prior art,

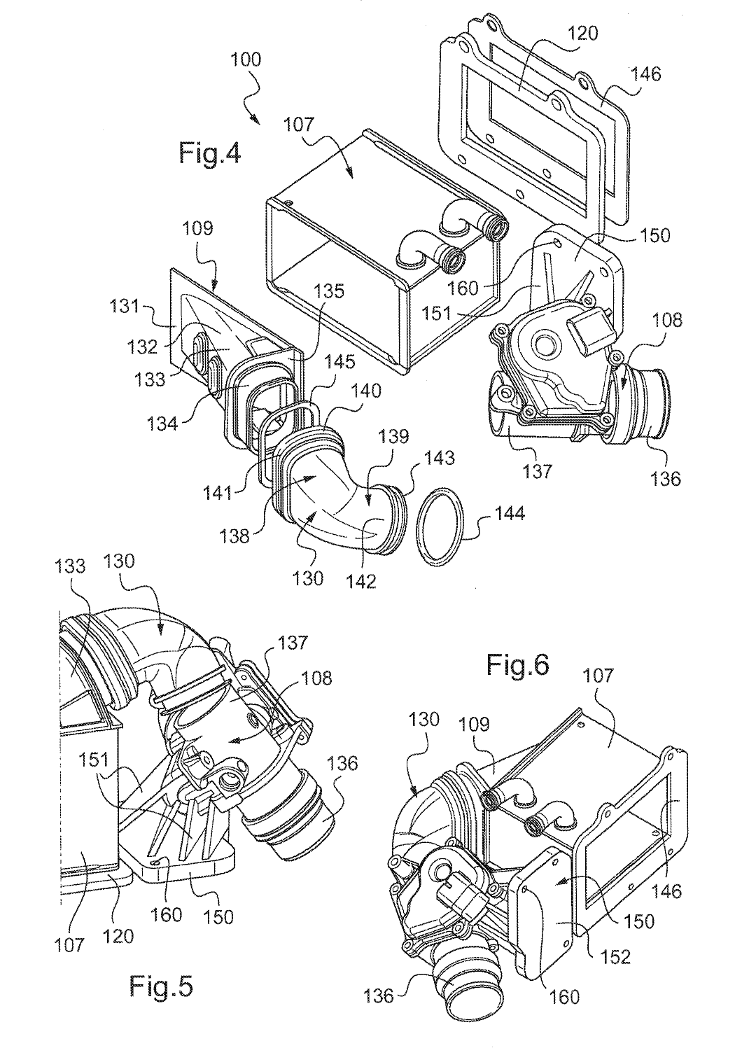

FIG. 4 is a partially exploded view of a module for supplying gas according to the invention,

FIG. 5 is a perspective view of a module for supplying gas to a vehicle engine according to the invention,

FIG. 6 is a perspective view at another angle of the module from FIG. 5.

FIGS. 1, 2 and 3 have already been described. With reference to FIG. 4, a module 100 for supplying gas to a motor vehicle comprises a single dispenser 108, an intake box 109, a cooler 107, a connecting duct 130 between said single dispenser 108 and said intake box 109, and an interface flange 120.

The cooler 107 is a conventional cooling heat exchanger, which is formed by a substantially parallelepipedal rectangular component and to which the intake box 109 is fixed. Said box 109 has a flat face 131 provided with a rectangular central opening, said face 131 being surmounted by an oblique tube 132, a first end of which is formed by said central opening. The term “oblique” means that said tube 132 is neither perpendicular nor parallel to the plane of the flat surface 131. A second end 133 of the tube 132 is extended by an end piece 134 that has a rectangular section, the four corners of which are rounded, said end piece 134 extending in a longitudinal direction of said tube 132. This end piece 134 starts in the region of a widened stop wall 135, the surface plane of which is perpendicular to the longitudinal axis of the tube 132. The outer surface of this end piece 134 is smooth.

The single dispenser 108 comprises an air inlet passage 136 originating from a supercharger 5, and an air outlet passage 137 intended to be placed in communication with the intake box 109. The independent duct 130, which is provided to connect the intake box 109 to the air outlet passage 137 of the single dispenser 108 has an elbow that makes it possible to distinguish a first flared segment 138 and a second segment 139 having a smaller size, said segments 138, 139 forming an angle of close to 90° between one another. A free end 140 of the first segment 138 has a rectangular section, the four corners of which are rounded, the dimensions of said section being greater than the dimensions of the rectangular section of the end piece 134 of the oblique tube 132 of the intake box 109. This first free end 140 of the duct 130, which is intended to be forcibly interlocked by sliding around the end piece 134 of the intake box 109, has a peripheral external overthickness 141, formed by a series of annular ribs located side by side, said overthickness being designed to allow good manipulation of the duct 130 at the time of said interlocking.

A first annular lip seal 145 is intended to be inserted between the free end 140 of the first segment 138 and the end piece 134 of the intake box 109, in order to ensure proper leak tightness between said box 109 and the single dispenser 108. A free end 142 of the second segment 139 has a circular section, the wall delimiting said free end being widened by means of two parallel annular flanges 143 that emerge from the outer surface thereof. A second annular seal 144 is designed to be inserted between said flanges 143. The free end 142 of this second segment 139 is intended to be forcibly inserted by rotation into the air outlet passage 137 of the single dispenser 108, said second seal 144 being dimensioned to ensure proper leak tightness between the independent duct 130 and the single dispenser 108. The interlocking connection established between the independent duct 130 and the intake box 109 is of the sliding type, while the interlocking connection implemented between this duct 130 and the single dispenser 108 is of the ball joint type. The interface flange 120 is intended to flank one face of the cooler 107, being secured to said cooler 107. A seal 146 having the same profile as that of the interface flange 120 is provided to be pressed against said flange 120 and thus provide proper sealing with the cylinder head of the engine 6 on which the cooler 107 will be anchored.

With reference to FIGS. 4, 5 and 6, the single dispenser 108 is provided with a flat fixing tab 150 having a small thickness and an approximately rectangular contour. This fixing tab 150 is connected to the single dispenser by a plurality of flat connecting arms 151 having a small thickness. These arms 151 are implanted regularly over the entire surface of the fixing tab 150 so as to ensure a homogeneous and solid connection of said tab 150 to said single dispenser 108.

The fixing tab 150 is penetrated by orifices 160 provided for the passage of screws so that the single dispenser 108 is fixed to the cylinder head of the engine 6 by screwing. As FIG. 6 shows, all the constituent elements of the module 100 according to the invention, namely the cooler 107, the intake box 109, the connecting duct 130, the single dispenser 108 and the valve 115 of the high-pressure EGR circuit, are arranged with respect to one another such that the connecting tab 150 secured to the single dispenser 108, and the interface flange 120 connected to the cooler 107, are located in the same plane, in line with one another. In other words, a flat surface 152 of said tab 150, which is located outside said module 100, is flush with a flat surface of the seal 146 attached to the interface flange 120. In this way, once fitted, the module 100 according to the invention has a strictly flat and smooth side, with no reliefs.

Once the module 100 has been fitted in the vehicle, the cooler 107 and the single dispenser 108 are fixed directly to the cylinder head of the engine 6. The single dispenser 108 consequently has two anchoring points, the first on the intake box 109 and the second on said cylinder head of the engine 6, removing the cantilever effect currently observed in already existing modules 18 for supplying gas. The modules 100 for supplying gas according to the invention are homogeneous, solid and compact, reducing, or even doing away with potential zones of structural weakness within said modules 100.

1. A module for supplying gas to an engine of a motor vehicle, comprising:
a single dispenser;
a gas cooler provided with means for fixing to the cylinder head of said engine; and
an intake box connecting said single dispenser to said cooler, the single dispenser comprising means for fixing to the cylinder head of said engine.

2. The module as claimed in claim 1, wherein the means for fixing the single dispenser and the means for fixing the cooler are positioned on the same side of said module.

3. The module as claimed in claim 2, wherein the means for fixing the cooler and the means for fixing the single dispenser are arranged on said module so as to ensure a connection of said dispenser and of said cooler with the cylinder head of the engine in the same plane.

4. The module as claimed in claim 3, wherein the means for fixing the single dispenser is a flat fixing tab.

5. The module as claimed in claim 4, wherein the means for fixing the cooler to the cylinder head comprise an interface flange, and the fixing tab of the single dispenser is flush with said interface flange.

6. The module as claimed in claim 5, wherein the interface flange and the fixing tab are positioned side by side.

7. The module as claimed in claim 4, wherein the fixing tab has at least one through-orifice provided for a screw.

8. The module as claimed in claim 7, wherein the fixing tab has no through-orifices other than those provided for the screws.

9. The module as claimed in claim 1, wherein the single dispenser is connected to the intake box by a duct, and at least one of the two connections implemented to ensure this connection is produced by interlocking.
